(19) United States
(12) Patent Application Publication
(10) Pub. No.: US 2024/0332970 A1
(43) Pub. Date: Oct. 3, 2024

(54) SYSTEMS AND METHODS FOR MANAGING ELECTRICAL POWER IN A WORKSITE

(71) Applicant: Caterpillar Inc., Peoria, IL (US)

(72) Inventors: Corey Lee Gorman, Peoria, IL (US); Matthew Alan Bunge, Rapid City, SD (US); Koji Kishida, Hyogo (JP); Andy Man Chung Fung, Kobe city (JP); Justin Douglas Speichinger, Morton, IL (US); David E. Cooper, Chillicothe, IL (US)

(73) Assignee: Caterpillar Inc., Peoria, IL (US)

(21) Appl. No.: 18/192,450

(22) Filed: Mar. 29, 2023

(51) Int. Cl. H02J 3/14; H02J 3/38

(52) U.S. Cl. CPC H02J 3/144; H02J 3/381

(57) ABSTRACT

Systems and methods for managing electrical power at a worksite are described herein. A control system determines available sources of electrical power at the worksite. The control system establishes communications with one or more work machines at the worksite and commences monitor power usage of the one or more work machines. Upon receiving an indication that a work machine requires power, the control system determines the type of power to be used by the work machine. The types of power can include a grid power supply and a portable power supply. If the portable power supply is required, the control system transmits an instruction to move the portable power supply to the location where the electrical power is to be used.

### TECHNICAL FIELD

The present disclosure relates to a system and method for managing electrical power in a worksite, and more particularly, for providing multiple sources of electrical power in a worksite.

### BACKGROUND

Users of work machines, such as excavators, haulers, diggers, pavers, and the like, are increasingly requiring construction and earthmoving solutions that allows them to meet both government and self-directed greenhouse gas (GHG) reduction targets. Several solutions allow for zero emissions machine operation. These solutions include battery-electric, fuel-cell electric, and tethered-electric machines. Due to the much lower energy density of batteries and hydrogen, it can be difficult to achieve operating durations similar to today's diesel-powered offerings. When a site and machine application allow, it is often preferred to operate with a tethered-electric solution. However, when operating with a tethered-electric machine, the machine is limited to the operating range that is the length of the tether and its proximity to an electric power source (usually the electric grid or a site microgrid). In addition, tethered-electric machines are often connected to power sources other than the grid.

An example of power supply management is described in U.S. Patent Appl. No. 20210291692 to Neda Masoud et. al. (hereinafter referred to “the '692 application”). The '692 application describe the use of a tether to transfer power from one moving vehicle to another vehicle. The vehicle receiving the power can use the transferred electrical power for propulsion in. an enhanced charge mode whereby a state of charge of the battery is increased. However, the system described in the '692 application requires that the machine receiving the power stays within a specific distance (i.e., the length of the tether) from the source of the power.

Examples of the present disclosure are directed toward overcoming one or more of the deficiencies noted above.

### SUMMARY

In one aspect of the presently disclosed subject matter, a control system for managing electrical power at a worksite includes one or more processors, and one or more non-transitory computer-readable media storing computer-executable instructions that, when executed by the one or more processors, cause the one or more processors to perform acts comprising receiving, by the control system, a communication that a first portable power supply disposed at the worksite is required for use by a work machine, the work machine being disposed at the worksite and receiving power from at least one of a grid power supply of the worksite or a second portable power supply, determining, by the control system, that the first portable power supply is available for use by the work machine, and based on determining that the first portable power supply is available for use, communicating, by the control system, an instruction to move the first portable power supply a location for use by the work machine.

In another aspect of the presently disclosed subject matter a method for managing electrical power at a worksite includes establishing, by a control system, an energy capacity of a plurality of power sources, the plurality of power sources comprising a grid power supply and a portable power supply, establishing, by the control system, communication with a work machine located at the worksite, monitoring, by the control system, a power requirement for the work machine, receiving, by the control system, a communication that the portable power supply is required for use by the work machine currently using the grid power supply or a second portable power supply, determining, by the control system, that the portable power supply is available for use by the work machine, and communicating, by the control system, an instruction to move the portable power supply to a location for use by the work machine.

In a still further aspect of the presently disclosed subject matter, a work machine includes an electric motor, a battery powering the electric motor, an electrical control module (ECM) comprising one or more processors, and one or more non-transitory computer-readable media storing computer-executable instructions that, when executed by the one or more processors, cause the one or more processors to perform acts comprising transmitting, to a control system, a request for a portable power supply at a second location, wherein the work machine is currently receiving electrical power from a first power supply at a first location, transmitting, to the control system, current charge data, receiving, from the control system a permission notice indicating that the work machine can be disconnected from the second power supply.

### BRIEF DESCRIPTION OF THE DRAWINGS

The detailed description is described with reference to the accompanying figures. In the figures, the left-most digit or digits of a reference number identifies the figure in which the reference number first appears.

FIG. 1 illustrates an example worksite in which various sources of electrical power are managed, in accordance with various examples of the presently disclosed subject matter.

FIG. 2 illustrates the use of a grid power supply for use by a haul truck, in accordance with various examples of the presently disclosed subject matter.

FIG. 3 illustrates the use of a portable power supply for use by a haul truck, in accordance with various examples of the presently disclosed subject matter.

FIG. 4 illustrates the use of a regenerative capture system using a pantograph assembly to receive electrical power from a haul truck, in accordance with various examples of the presently disclosed subject matter.

FIG. 5 illustrates a method for managing electrical power at a worksite, in accordance with various examples described herein

FIG. 6 depicts a component level view of a control system for use with the systems and methods described herein.

### DETAILED DESCRIPTION

Wherever possible, the same reference numbers will be used throughout the drawings to refer to the same or like parts.

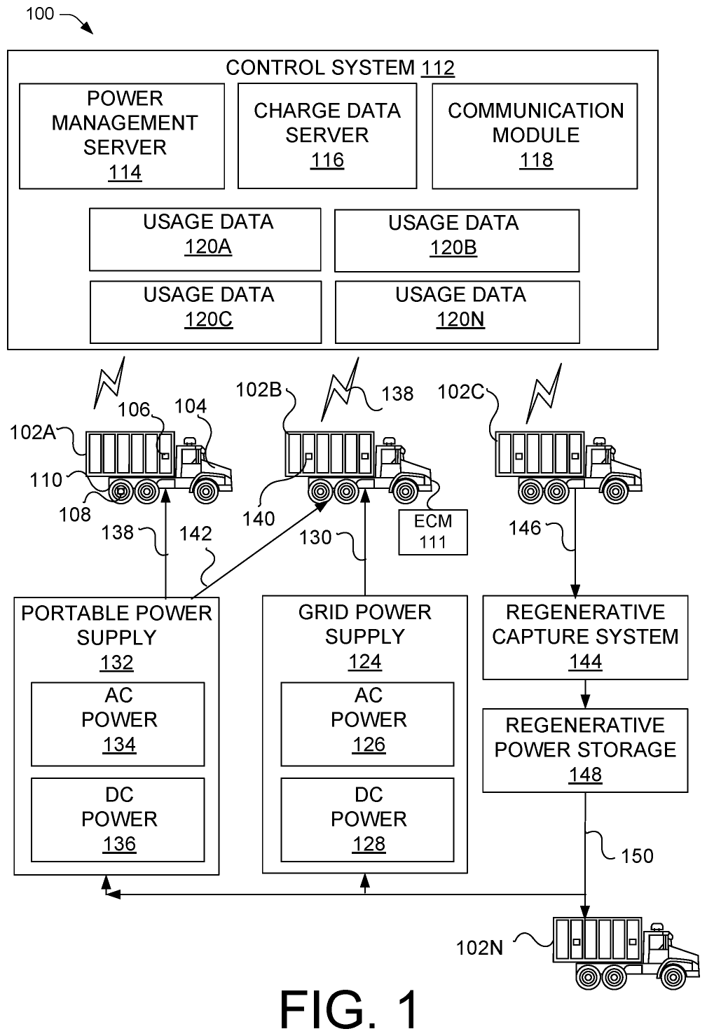

FIG. 1 illustrates an example worksite 100 in which various sources of electrical power are managed, in accordance with various examples of the presently disclosed subject matter. The worksite includes haul trucks 102A-102N (hereinafter referred to individually as “the haul truck 102A,” “the haul truck 102B,” and the like, and generally as “the haul trucks 102) It should be noted that the presently disclosed subject matter is not limited to haul trucks 102, as the technologies described herein are applicable to other types of work machines such as compaction machines, paving machines, milling machines, excavators, wheel loaders, track-type tractors, and other machines used in mining, paving, farming, construction, or other environments. The example haul trucks 102 use electrical power, in accordance with various examples of the presently disclosed subject matter. In some examples, the haul trucks 102 are hybrid vehicles, meaning that the haul trucks 102 and their various components can be powered by various systems. For example, the haul truck 102A includes an internal combustion engine 104, a battery 106, and/or other type of prime mover. When the haul truck 102A is powered by a prime mover such as the internal combustion engine 104, the internal combustion engine 104 can power a generator (not shown) to provide electrical power to various components, such as an electric motor 108 that, when powered, rotates a wheel 110 to cause movement of the haul truck 102A. The presently disclosed subject matter is not limited to any particular type of prime mover and, for example, any type of internal combustion engine 104. The haul trucks 102B-102N, for the purposes of describing the examples illustrated in FIG. 1, are similarly configured.

As the haul trucks 102 are operated, the haul trucks 102 may require various forms of energy at various locations. In some worksites, such as the worksite 100 of FIG. 1, the haul trucks 102 may be moved about the worksite 100, may be moved off of the worksite 100 to another location or worksite, or may be moved from one location of the worksite 100 to another location of the worksite 100. Additionally, the haul trucks 102 may be used in one manner (e.g., to perform a first task) during one time period and another manner (e.g., to perform a second task different from the first task) in a second time period. For example, the haul trucks 102 may be used for transporting material when loaded, during a first time period, but otherwise may sit idle during a second time period once moved into position for loading. Thus, the power requirements, and the location of the availability of the power, may change (or be dynamic) throughout the day or over a period of time.

To manage and provide for variable power requirements, the worksite 100 includes a control system 112. The control system 112 may be located at the worksite 100, installed on one or more of the haul trucks 102 or other work machines (not shown), or may be in a remote location off the worksite 100. The control system 112 is a computing system that monitors the power needs of the haul trucks 102 (as well as other work machines if in use), and reconfigures the location, type, and availability of the power to meet the requirements. It should be noted that although the control system 112 is illustrated as a centralized system serving more than one of the haul trucks 102, each of the haul trucks 102 may have a local control system 112 onboard or assigned specifically to that particular haul truck 102. The description of FIG. 1, whereby the control system 112 is a centralized system, is merely for purposes of illustrating an example and not an intention to limit the scope of the presently disclosed subject matter.

The control system 112 includes a power management server 114, a charge data server 116, and a communication module 118. The power management server 114 receives usage data 120A-120N (hereinafter referred to individually as “the usage data 120A,” “the usage data 120B,” and the like, and generally as “the usage data 120”). The usage data 120 is an indication of the amount of power being used by each of the haul trucks 102 that is monitored by the control system 112. For example, the usage data 120A is the usage data of the haul truck 102A, the usage data 120B is the usage data of the haul truck 102B, and so forth. The usage data 120 may include data such as the current electrical loads (or current draw) from each of the haul trucks 102, potential future or projected electrical loads (or current draw) from each of the haul trucks 102, and the like. The power management server 114 further controls the distribution of various forms of electrical power (described in more detail below).

As noted above, the control system 112 further includes the charge data server 116. The charge data server 116 receives charge data about batteries that may be installed on the haul trucks 102. It should be noted that some haul trucks 102 may not have batteries installed, and thus, no charge data would be received from those haul trucks 102. In some examples, the haul trucks 102 may use batteries as a secondary source of electrical power when a primary source of electrical power is not available. For example, the haul truck 102A may be receiving a primary source of power at a current location of the haul truck 102A, but the haul truck 102A needs to be moved to another location of the worksite 100. To accomplish this, in some examples the haul truck 102A may be disconnected from the primary source of power during the transition from the one location of the worksite 100 to the second location of the worksite 100. During the transition, the haul truck 102A may rely on the battery 106 to provide the electrical power. Thus, while the power management server 114 monitors the availability of the various forms of electrical power available to the haul trucks 102, the charge data server 116 monitors the charge levels of the batteries of the haul trucks 102 in case the primary source of power is not available.

The primary sources of power may vary from worksite to worksite. The worksite 100 includes a grid power supply 124. The grid power supply 124 can provide various voltages of AC (alternating current) power 126 and/or DC (direct current) power 128. In some examples, the DC power 128 may be used to provide power to the haul trucks 102 as well as power to charge the battery, such as the battery 106. In some examples, the use of the DC power 128 can handle transient load conditions in a more efficient manner than the AC power 126 because the use of DC power 128 does not require the conversion of the AC power 134 to DC power 136 to charge the battery 106. Thus, the battery 106 can be used to provide additional electrical power in the transient condition. The grid power supply 124 can be provided by various sources including, but not limited to, an electric utility, a generator, a solar array, wind turbines and the like. As used herein, the grid power supply 124 is a relatively stationary source of electrical power, meaning electrical connectors that connect the AC power 126 or the DC power 128 to the haul truck 102B, such as a tether 130 from the grid power supply 124 to the haul truck 102B, remain in one general location. The grid power supply 124 would normally not be moved from one location to another to service any particular one of the haul trucks 102. In some examples, the grid power supply 124 is generally located in an area in which the grid power supply 124 can service several of the haul trucks 102 or service a haul truck 102 with a higher energy requirement than may be provided by a mobile power source, such as the portable power supply 132.

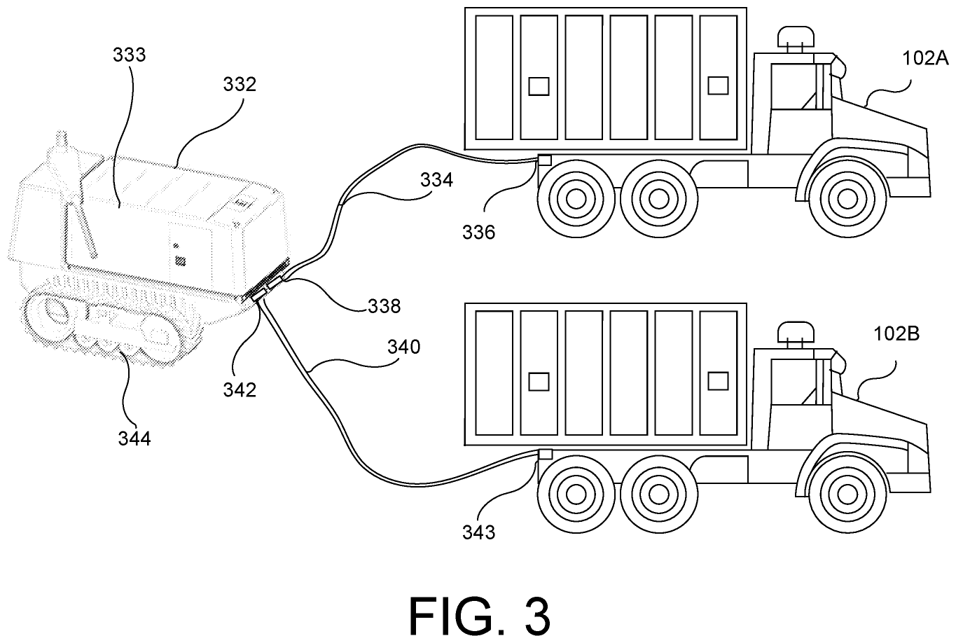

The portable power supply 132 can be comprised of various types of power supplies, an example of which is described in FIG. 3, below. The portable power supply 132 can provide various voltages of AC power 134 and/or DC power 136. The portable power supply 132, unlike the grid power supply 124, is designed to be moved from one location of the worksite 100 to another. The portable power supply 132 is comprised of one or more power supplies that can be moved to various locations (or one location) to service the power supplies needs determined by the power management server 114. In some examples, the portable power supply 132 can be used in the absence of, or to augment, the grid power supply 124.

To provide information to and from the control system 112, as well as perform other processing functions, the haul truck 102B includes an electrical control module (ECM) 111 that controls various aspects of the haul truck 102B. The ECM 111 includes single or multiple microprocessors, field programmable gate arrays (FPGAs), digital signal processors (DSPs), and/or other processors or components configured to control the haul truck 102C. Numerous commercially available microprocessors can be configured to perform the functions of the ECM 111. Various known circuits are operably connected to and/or otherwise associated with the ECM 111 and/or the other circuitry of the haul truck 102B. Such circuits and/or circuit components include power supply circuitry, inverter circuitry, signal-conditioning circuitry, actuator driver circuitry, etc. Additionally, such circuits and/or circuit components may comprise hardware components and/or software components, and one or more such components (e.g., software components) may be stored in a memory associated with the ECM 111. The present disclosure, in any manner, is not restricted to the type of ECM 111 or the positioning depicted of the ECM 111 and/or the other components relative to the haul truck 102B. In some uses, the ECM 111 communicates with the control system 112 conditions of the haul truck 102B that may require one or more actions of the control system 112, such as, but not limited to, a disconnection of power from the haul truck 102B.

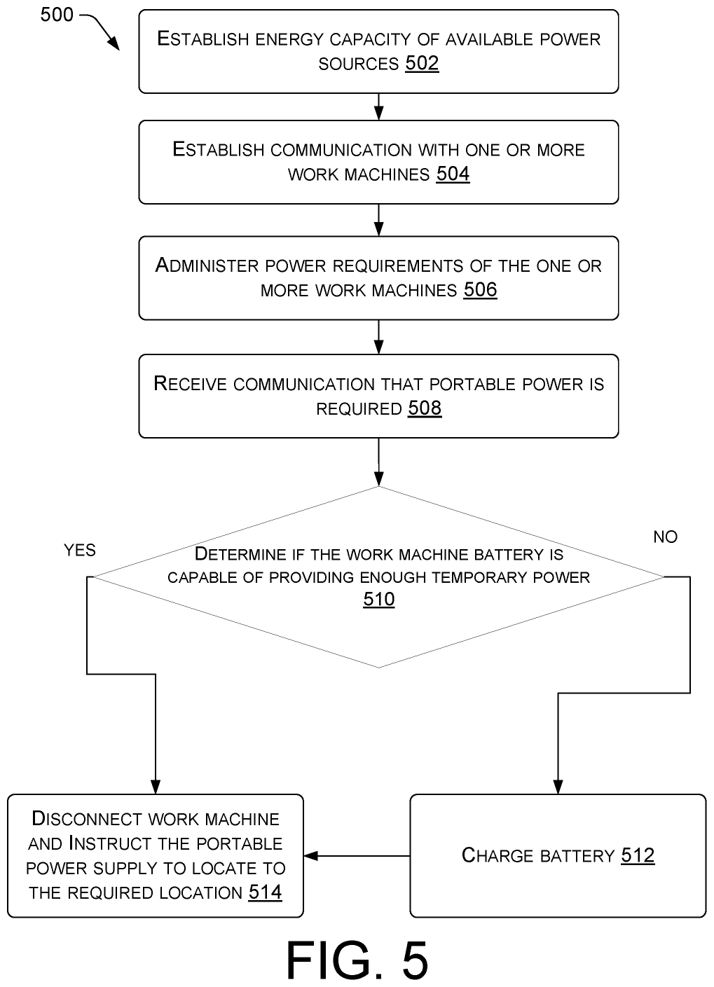

For example, the ECM 111 of the haul truck 102B may notify the control system 112 through a wireless communication 138 using a communication transceiver 140 installed on the haul truck 102B that the haul truck 102B needs to disconnect from the grid power supply 124 because the haul truck 102B is to be moved from the location of the worksite 100 that has the grid power supply 124 to another location of the worksite 100 in which the grid power supply 124 is not accessible. As explained in more detail by way of example in FIG. 5, below, the power management server 114 accesses the charge data server 116 to determine if the battery installed on the haul truck 102B is charged sufficiently to power the haul truck 102B through the transition from the grid power supply 124 to another power supply, such as another grid power supply or the portable power supply 132. If the power management server 114 determines that the battery on the haul truck 102B is not charged sufficiently, the power management server 114 instructs the haul truck 102B to increase the charge of the battery of the haul truck 102B. The power management server 114 may determine that the battery installed on the haul truck 102B is charged sufficiently to power the haul truck 102B by determining that the charge on the battery is sufficient to provide power to the haul truck 102B for the length of time and travel that the haul truck 102B is without power.

The power management server 114 also determines if the portable power supply 132 is needed at the second location. For example, the power management server 114 may determine if portable power supply 132 is already at the second location. If the portable power supply 132 is required because no portable power supply 132 is at the second location, or the current portable power supply 132 at the second location cannot provide enough power to supply the additional load required by the haul truck 102B, the power management server 114 locates an available one or more of the portable power supplies 132 and determines which and how many of the portable power supplies 132 are needed to supply the power to the haul truck 102B once the haul truck 102B arrives at the second location of the worksite 100. The power management server 114 then transmits an instruction using the communication module 118 that one or more of the portable power supplies 132 are to be relocated to the second location for use by the haul truck 102B. If the portable power supply 132 is an autonomous portable power supply, such as the example in FIG. 3, below, the portable power supply 132, after receiving the instruction, moves to the second location. If the portable power supply 132 needs manual labor to move (such as attaching to a vehicle driven by a worker), the communication may be the worker (not shown). Once at the second location, the haul truck 102B attaches to the portable power supply 132 using the tether 142. It should be noted that prior to moving, the tether 130 to the grid power supply 124 would have been removed. Once a power supply that is capable of serving the power requirements of the haul truck 102B is at the second location, the power management server 114 transmits a permission notice to the haul truck 102B that the haul truck 102B can be disconnected from the gid power supply (or a first power supply) to make the move from the first location to the second location. It should be noted that in some examples, the permission notice may not be used, or the transition made prior to receiving the permission notice.

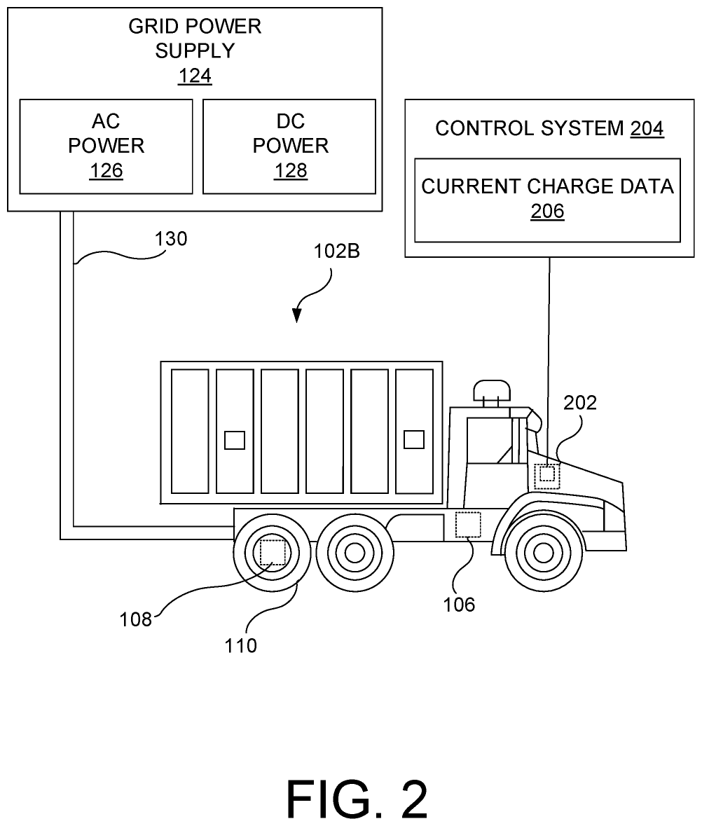

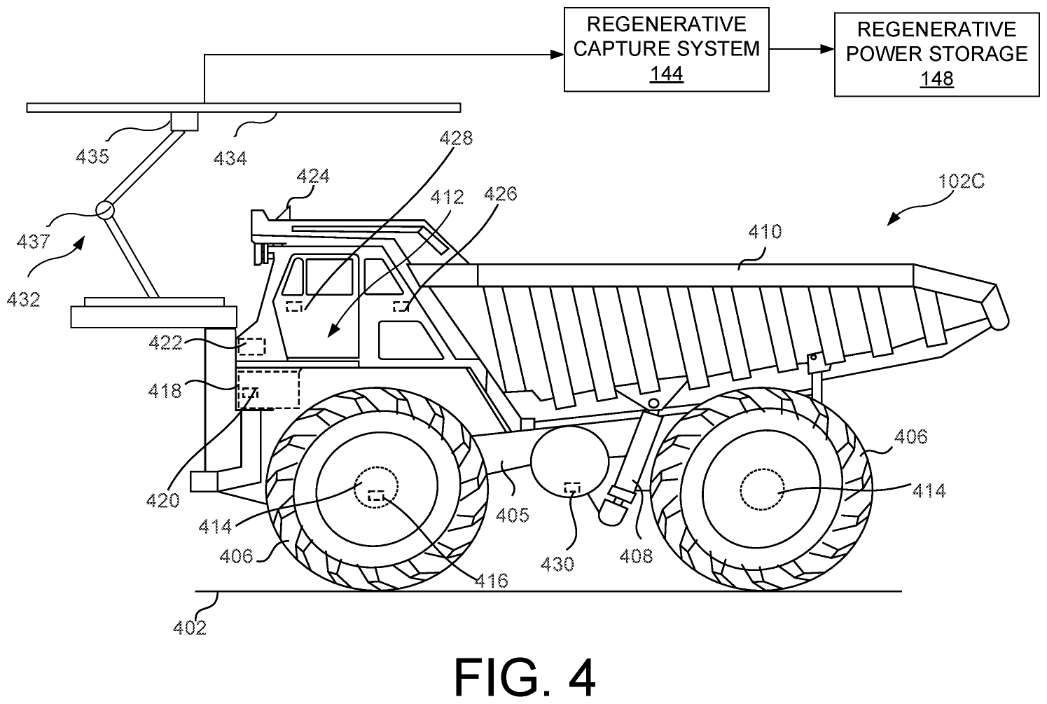

In some examples, the haul trucks 102 can generate electricity during use. For example, the haul trucks 102 can be outfitted with regenerated braking systems (not shown). These regenerative braking systems generate electricity when used. This electricity can be used to charge the battery 106. Also, because the battery 106 may be charged to a charge that is not needed by the haul truck 102 (e.g., the haul truck 102 is being stored or shutdown), the battery 106 may have an excess charge. If the amount of energy generated or stored exceeds the amount needed by the haul trucks 102, the excess energy (e.g., an excess charge) may be stored and applied to other uses. To recapture and use the excess charge, the worksite 100 further includes a regenerative capture system 144. The regenerative capture system 144 is designed to receive the excess charge from the haul trucks 102 and store it or transfer it to other electrical devices or work machines. The regenerative capture system 144 electrically connects to the haul trucks 102 and receives electrical power from the haul trucks 102 through the electrical connection 146, an example of which is described in FIG. 4. The electrical power received from the haul truck 102C received through the electrical connection 146 is stored in a regenerative power storage 148. The regenerative power storage 148 can be various types of storage technologies including, but not limited to, a battery. In other examples, the electrical power received from the haul truck 102C received through the electrical connection 146 can be converted to another form of energy (such as a hydrogen production unit that generates hydrogen gas using electrolysis of water using the electrical power received from the haul truck 102C) and stored in containers. The presently disclosed subject matter is not limited to any particular form of storage that the regenerative power storage 148 takes. The stored power may be provided to other haul trucks or work machines, such as the haul truck 102N, or used to supplement or augment power provided by the grid power supply 124, illustrated by way of example in FIG. 2, or portable power supply 132, illustrated by way of example in FIG. 3, through connector 150.

FIG. 2 illustrates the use of the grid power supply 124 by the haul truck 102B, in accordance with various examples of the presently disclosed subject matter. As described in FIG. 1, the haul truck 102B is connected to the grid power supply 124 through the tether 130. The tether 130 can be any type of connector that electrically connects the grid power supply 124 to an electrical system 202 of the haul truck 102. It should be noted that the presently disclosed subject matter is not limited to any particular type of connector. In the example illustrated in FIG. 1, the grid power supply 124 is the primary source of electrical power. The grid power supply 124 can vary in type including, but not limited to, a generator, a solar array, a power station, or power from an electric utility. The grid power supply 124 can be of various types, such as the AC power 126 and the DC power 128, as well as various voltages. The presently disclosed subject matter is not limited to any particular power source or type.

The grid power supply 124 is electrically and/or otherwise operably connected to the electrical system 202 of the haul truck 102 through the tether 130, whereby the electrical system 202 is operating in a primary power mode. In the primary power mode, the grid power supply 124 provides electrical power to the systems of the haul truck 102B to operate the haul truck 102B. The tether 130 can be comprised of one or more electrical power conduits having cabling capable of conducting current or supporting a voltage. The electrical system 202 includes a control system 204. The control system 204 may be a server, software module, hardware, or other type of component. The control system 204 is configured to control the distribution of the received grid power supply 124 in the primary power mode to the various components of the haul truck 102B depending on inputs received by an operator (not shown) of the haul truck 102B. For example, the control system 204 routes power to the electrical motor 108 to move the haul truck 102B when an input is received to perform that task.

The control system 204 can further determine how much of the grid power supply 124 received from the grid power supply 124 is directed to charging the battery 106 by comparing a desired charge and a determined charge rate. For example, the battery 106 may be charged to fifty percent (50%) of its maximum charge capacity but requires a charge rate of 1C. As used herein, “C” or “C-rate” is the rate at which a battery is fully charged or discharged. Thus, the control system 204 may direct a certain power level of the grid power supply 124 to be applied to the battery 106 to achieve the desired C or C-rate. It should be noted that although the control system 204 is illustrated and described as being a component of the haul truck 102B, various functions of the control system 204 may be performed by computers remote from the haul truck 102B, such as the control system 112 of FIG. 1. The control system 204 provides current charge data 206 to the charge data server 116 of FIG. 1. As noted above, the grid power supply 124 is a relatively fixed location of power. In case in which electrical power may need to be provided to areas not services by the grid power supply 124, the portable power supply 132 can be used, as illustrated in FIG. 3.

FIG. 3 illustrates the use of a portable power supply 332 for use by the haul trucks 102A and 102B, in accordance with various examples of the presently disclosed subject matter. The portable power supply 332 includes one or more power sources 333 that may be used by the haul trucks 102A and 102B for power needs. The power sources 333 may include, but are not limited to, batteries, fuel cells, internal combustion engine generators, and the like. As noted above, in areas of the worksite 100 in which power is required by not suppliable by other power sources, such as the grid power supply 124, a portable power supply, such as the portable power supply 332, may be used to deliver power to the location. In this example, the haul truck 102A is electrically connected, and receiving power from, the portable power supply 332 through tether 334 connected to electrical receiver port 336. The tether 334 is connected to a DC connector 338 of the portable power supply 332. Thus, the haul truck 102A is receiving the DC power 136 from the portable power supply 332. Further, in the example illustrated in FIG. 3, the haul truck 102B is electrically connected, and receiving power from, the portable power supply 332 through tether 340 connected to electrical receiver port 343. The tether 340 is connected to an AC connector 342 of the portable power supply 332. Thus, the haul truck 102B is receiving the AC power 134 from the portable power supply 332.

The portable power supply 332 may be moved from one location to another, as discussed above. In FIG. 3, the portable power supply 332 includes tracks 344. The tracks 344 may be rotated by the portable power supply 332 to move the portable power supply 332 from one location to another. For example, the power management server 114 of FIG. 1 may determine that the portable power supply 332 is required in a location of the worksite 100. The power management server 114 may communicate a move command using the communication module 118 to the portable power supply 332 to move to the required location. As noted above, the portable power supply 332 may be movable using other technologies, such as connecting the portable power supply 332 to a trailer or hitch of a truck and using the truck or vehicle to move the portable power supply 332. Further, as discussed above, the portable power supply 332, in addition to the other power supplies may be supplemented or augmented by energy captured by the regenerative capture system 144, shown by way of example in FIG. 4.

FIG. 4 illustrates the use of the regenerative capture system 144 of FIG. 1 using a pantograph assembly 432 to receive electrical power from the haul truck 102C, in accordance with various examples of the presently disclosed subject matter. The haul truck 102C, although depicted as a mining truck or haul truck, may be any suitable machine, such as any type of loader, dozer, dump truck, skid loader, excavator, compaction machine, backhoe, combine, crane, drilling equipment, tank, trencher, tractor, any suitable stationary machine, any variety of generator, locomotive, marine engines, combinations thereof, or the like. In some examples, the work machine can be a hybrid system, an electric vehicle (no internal combustion engine), or use internal combustion as the primary source of energy. The presently disclosed subject matter is not limited to any particular platform of use and may be implemented across various types of vehicles, installations (i.e., non-vehicle uses), and the like. The haul truck 102C of FIG. 4 is merely for purposes of illustration.

As shown in FIG. 4, the haul truck 102C includes a frame 405 and wheels 406. The wheels 406 are mechanically coupled to a drive train (not shown) to propel the haul truck 102C. When the wheels 406 of the haul truck 102C are caused to rotate, the haul truck 102C traverses the surface 402. Although illustrated in FIG. 4 as having a hub with a rubber tire, in other examples, the wheels 406 may instead be in the form of drums, chain drives, tracks, combinations thereof, or the like. The frame 405 of the haul truck 102C is constructed from any suitable materials, such as iron, steel, aluminum, other metals, ceramics, plastics, combination thereof, or the like. The frame 405 is of a unibody construction in some cases, and in other cases, is constructed by joining two or more separate body pieces. Parts of the frame 405 are joined by any suitable variety of mechanisms, including, for example, welding, bolts, screws, other fasteners, epoxy, combinations thereof, or the like.

The haul truck 102C may include a hydraulic system 408 that moves a dump box 410 or other moveable elements configured to move, lift, carry, and/or dump materials. The dump box 410 is used, for example, to pick up and carry dirt or mined ore from one location on the surface 402 to another location of the surface 402. The dump box 410 is actuated by the hydraulic system 408, or any other suitable mechanical system. In some cases, the hydraulic system 408 is powered by an electric motor (not shown), such as by powering hydraulic pump(s) (not shown) of the hydraulic system 408. It should be noted that in other types of machines (e.g., machines other than a mining truck) the hydraulic system 408 may be in a different configuration than the one shown herein, may be used to operate elements other than a dump box 410, and/or may be omitted.

With continued reference to FIG. 4, the haul truck 102C also includes an operator station 412. The operator station 412 is configured to seat an operator (not shown) therein. The operator seated in the operator station 412 interacts with various control interfaces and/or actuators within the operator station 412 to control movement of various components of the haul truck 102C and/or the overall movement of the haul truck 402C itself. Thus, control interfaces and/or actuators within the operator station 412 allow the control of the propulsion of the haul truck 102C by controlling operation of one or more motors 414 that are electric motors, the motors 414 being controlled by a motor controller 416 and powered by a battery 418. The motor controller 416 may be controlled according to operator inputs received at the operator station 412. A battery controller 420 monitors and controls various aspects of the battery 418, such as controlling a temperature of the battery 418 or preventing an over discharge condition.

The motors 414 may be of any suitable type, such as induction motors, permanent magnet motors, switched reluctance (SR) motors, combinations thereof, or the like. The motors 414 are of any suitable voltage, current, and/or power rating. The motors 414 when operating together are configured to propel the haul truck 102C as needed for tasks that are to be performed by the haul truck 102C. For example, the motors 414 may be rated for a range of about 500 volts to about 3000 volts. The motor controller 416 include one or more control electronics to control the operation of the motors 414. In some cases, each motor 414 may be controlled by its own motor controller 416. In other cases, all the motors of the haul truck 102C may be controlled by a single motor controller 416. The motor controller 416 may further include one or more inverters or other circuitry to control the energizing of magnetic flux generating elements (e.g., coils) of the motors 414. The motors 414 are mechanically coupled to a variety of drive train components, such as a drive shaft and/or axles or directly to the wheels 406 to rotate the wheels 406 and propel the haul truck 102C. The drivetrain includes any variety of other components including, but not limited to a differential, connector(s), constant velocity (CV) joints, etc.

The battery 418 may be of any suitable type and capacity. For example, the battery may be a lithium-ion battery, a lead-acid battery, an aluminum ion battery, a flow battery, a magnesium ion battery, a potassium ion battery, a sodium ion battery, a metal hydride battery, a nickel metal hydride battery, a cobalt metal hydride battery, a nickel-cadmium battery, a wet cell of any type, a dry cell of any type, a gel battery, combinations thereof, or the like. The battery 418 may be organized as a collection of electrochemical cells arranged to provide the voltage, current, and/or power requirements of the motors 414.

The haul truck 102C includes an electrical control module (ECM) 422 that controls various aspects of the haul truck 102C. The ECM 422 includes single or multiple microprocessors, field programmable gate arrays (FPGAs), digital signal processors (DSPs), and/or other processors or components configured to control the haul truck 102C. Numerous commercially available microprocessors can be configured to perform the functions of the ECM 422. Various known circuits are operably connected to and/or otherwise associated with the ECM 422 and/or the other circuitry of the haul truck 102C. Such circuits and/or circuit components include power supply circuitry, inverter circuitry, signal-conditioning circuitry, actuator driver circuitry, etc. Additionally, such circuits and/or circuit components may comprise hardware components and/or software components, and one or more such components (e.g., software components) may be stored in a memory associated with the ECM 422. The present disclosure, in any manner, is not restricted to the type of ECM 422 or the positioning depicted of the ECM 422 and/or the other components relative to the haul truck 102C. The ECM 422 is configured to control the use of energy from the battery 418 in a manner that enhances the range of the haul truck 102C or to discharge excess energy from the battery 418.

The ECM 422 is configured to receive battery status (e.g., state-of-charge (SOC) or other charge related metrics such as the current charge data 206 of FIG. 2) from the battery controller 420, a fuel level from a sensor of the fuel tank controller 430, operator signal(s), such as an accelerator signal, based at least in part on the operator's interactions with one or more control interfaces and/or actuators of the haul truck 102C. In other cases, the ECM 422 may receive control signals from a remote-control system, such as the communication module 118 of FIG. 1, by wireless signals received via an antenna 424. The ECM 422 uses the operator signal(s), regardless of whether they are received from an operator in the operator station 412 or from a remote controller, to generate command signals to control various components of the haul truck 102C. For example, the ECM 422 may control the motors 414 via the motor controller 416, the hydraulic system 408, and/or steering of the haul truck 102C via a steering controller 426. It should be understood that the ECM 422 may control any variety of other subsystems of the haul truck 102C that are not explicitly discussed here to provide the haul truck 102C with the operational capability discussed herein.

The ECM 422, according to examples, may be configured to provide an indication of excess power generated by the haul truck 102C using regenerative braking or energy stored in the battery without the use of regenerative braking but the haul truck 102C does not need on an energy gauge 428. The amount of excess energy may be transmitted to the control system 112. The control system 112 may determine that the excess energy is to be stored in the regenerative power storage 148. In this example, the control system 112 transmits an instruction to the haul truck 102C to move the pantograph assembly 432 mounted at the front of the haul truck 102C to electrically connect with overhead conductors 434, or otherwise connected to and/or supported by the frame 405. Alternatively, the haul truck 102C may include two or more pantograph assemblies 432 connected to and/or supported by the frame 405. In such examples, the two or more pantograph assemblies can be controlled to be raised and lowered together.

The pantograph assembly 432 may be configured to receive electrical power from the haul truck 102C thru the overhead conductors 434 of the pantograph assembly 432 through electrical connector 435. The electrical connector 435 may be raised to be placed in contact with the overhead conductors 434, and thereafter lowered, using arm 437. Electrical power from the overhead conductors 434 is provided to the regenerative power storage 148 for use by other systems or machines, such as the haul truck 102N of FIG. 1. The pantograph assembly 432 is in electrical communication with the battery 418, thereby directly receiving electrical power from the haul truck 102C battery 418 to the regenerative power storage 148. For simplicity in description and clarity of illustration, the electrical components of the pantograph assembly 432 are not shown in the drawings except where the components are helpful for a complete description of the embodiments in accordance with the present disclosure.

FIG. 5 illustrates a method 500 for managing electrical power at a worksite 100, in accordance with various examples described herein. The method 500 and other processes described herein are illustrated as example flow graphs, each operation of which may represent a sequence of operations that can be implemented in hardware, software, or a combination thereof. In the context of software, the operations represent computer-executable instructions stored on one or more tangible computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. The processes illustrated herein may be performed by any of the processors/controllers described herein, but for case of description, the control system 112 will be referred to unless otherwise noted.

The method 500 commences at step 502, where the control system 112 established the energy capacity of available source of power to be used by the haul trucks 102 at the worksite 100. The available sources of power can include one or more portable power supplies 132 and one or more grid power supplies 124. The grid power supply 124 can provide various voltages of AC power 126 and/or DC power 128. As used herein, the grid power supply 124 is a stationary source of electrical power that connect the AC power 126 or the DC power 128 to the haul truck 102B, such as a tether 130 from the grid power supply 124 to the haul truck 102B, whereby the grid power supply 124 is designed to remain in one general location. The grid power supply 124 would normally not be moved to service any particular one of the haul trucks 102. The portable power supply 132 can provide various voltages of AC power 134 and/or DC power 136. The portable power supply 132, unlike the grid power supply 124, is designed to be moved from one location of the worksite 100 to another.

At step 504, the control system 112 establishes communication with one or more work machines, such as the haul trucks 102. The control system 112 uses the communication module 118 to receive various data from the haul trucks 102, including, but not limited to, the usage data 120 for the haul trucks 102. The usage data 120 is data indicating the power being used by each of the haul trucks 102 being monitored by the control system 112. For example, the usage data 120A is the usage data of the haul truck 102A, the usage data 120B is the usage data of the haul truck 102B, and so forth. The usage data 120 may include data such as the current electrical loads of each of the haul trucks 102, potential future or projected electrical loads of each of the haul trucks 102, and the like.

At step 506, the control system 112 commences administering the power requirement using the usage data 120 and other information. The control system 112 monitors usage data 120 in order to determine if the one or more power sources available at the worksite 100 are sufficient to provide the power or need to be relocated. For example, if the control system 112 determines that the usage data 120 is higher than what is available, the control system 112 may transmit a command signal to have a second portable power supply to provide power.

At step 508, the control system 112 receives a communication that portable power is required. For example, the haul truck 102B may notify the control system 112 through the wireless communication 138 using the communication transceiver 140 installed on the haul truck 102B that the haul truck 102B needs to disconnect from the grid power supply 124 because the haul truck 102B is to be moved from the location of the worksite 100 that has the grid power supply 124 to another location of the worksite 100 at which the grid power supply 124 is not available.

At step 510, the power management server 114 of the control system 112 accesses the charge data server 116 to determine if the battery installed on the haul truck 102B is charged sufficiently to power the haul truck 102B through the transition. In some examples, the power manager server 114 calculates a projected amount of power required for use by the haul truck 102B during the transition. The battery charge is sufficient if the power management server 114 determines that the battery is capable of discharging the required power during the transition prior to being reconnected to a power supply.

At step 510, if the power management server 114 determines that the battery on the haul truck 102B is not charged sufficiently, at step 512, the power management server 114 instructs the haul truck 102B to increase the charge of the battery of the haul truck 102B.

At step 514, the power management server 114 of the control system 112 informs the haul truck 102B to disconnect from the grid power supply 124 and relocate to the second location. In some examples, the power management server 114 of the control system 112 instructions one or more portable power supplies to relocate to the second location to power the haul truck 102B.

If at step 510, the power management server 114 determines that the battery on the haul truck 102B is charged sufficiently to make the transition from the first location to the second location, at step 514, the power management server 114 of the control system 112 informs the haul truck 102B to disconnect from the grid power supply 124 and relocate to the second location.

The power management server 114 also determines if the haul truck 102B is capable of making the transition, and adjusting battery charges if needed, the power management server 114 locates an available one or more of the portable power supplies 132. The control system 112 further determines which and how many of the available portable power supplies 132 are needed to supply the power to the haul truck 102B once the haul truck 102B arrives at the second location of the worksite 100.

At step 512, the power management server 114 then transmits an instruction using the communication module 118 that one or more of the portable power supplies 132 are to be relocated to the second location for use by the haul truck 102B. If the portable power supply 132 is an autonomous (capable of being remoted controlled or is computer operated) portable power supply, the portable power supply 132, after receiving the instruction, moves to the second location. If the portable power supply 132 needs manual labor to move (such as attaching to a vehicle driven by a worker), the communication may be the worker. The haul truck 102B may thereafter connect to the portable power supply 132.

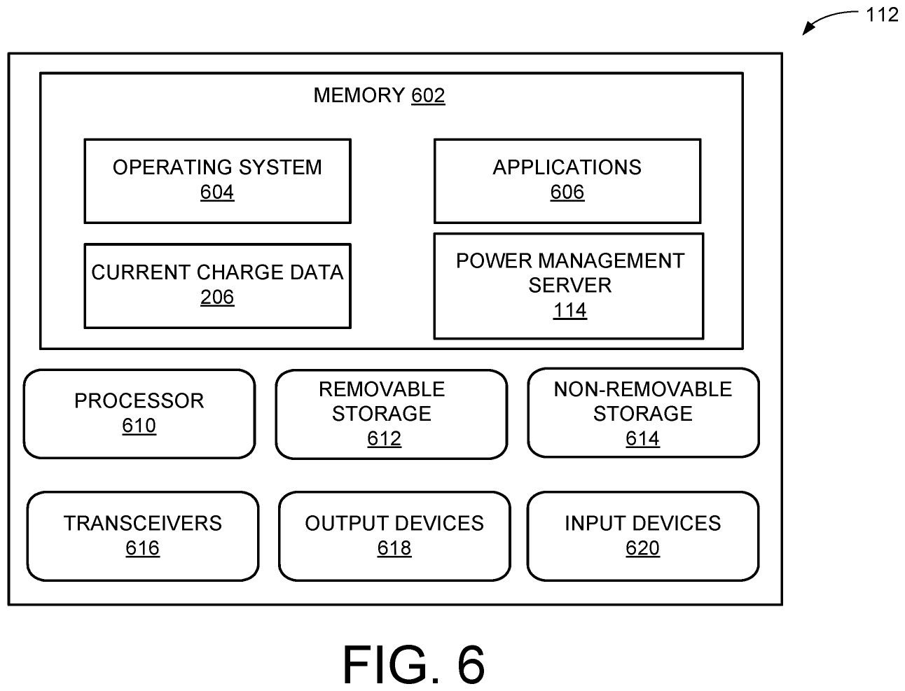

FIG. 6 depicts a component level view of the control system 112 for use with the systems and methods described herein. The control system 112 could be any device capable of providing the functionality associated with the systems and methods described herein. The control system 112 can comprise several components to execute the above-mentioned functions. The control system 112 may be comprised of hardware, software, or various combinations thereof. As discussed below, the control system 112 can comprise memory 602 including an operating system (OS) 604 and one or more standard applications 606. The standard applications 606 may include applications that provide for receiving and determining battery information, such as the current charge data 206, that are used to implement the method 500 of FIG. 5. The memory 602 can also include other applications such as the power management server 114.

The control system 112 can also comprise one or more processors 610 and one or more of removable storage 612, non-removable storage 614, transceiver(s) 616, output device(s) 618, and input device(s) 620. In various implementations, the memory 602 can be volatile (such as random access memory (RAM)), non-volatile (such as read only memory (ROM), flash memory, etc.), or some combination of the two. The memory 602 can include data pertaining to the battery 106.

The memory 602 can also include the OS 604. The OS 604 varies depending on the manufacturer of the control system 112. The OS 604 contains the modules and software that support basic functions of the control system 112, such as scheduling tasks, executing applications, and controlling peripherals. The OS 604 can also enable the control system 112 to send and retrieve other data and perform other functions, such as transmitting control signals using the transceivers 616 and/or output devices 618 and receiving load conditions using the input devices 620.

The control system 112 can also comprise one or more processors 610. In some implementations, the processor(s) 610 can be one or more central processing units (CPUs), graphics processing units (GPUS), both CPU and GPU, or any other combinations and numbers of processing units. The control system 112 may also include additional data storage devices (removable and/or non-removable) such as, for example, magnetic disks, optical disks, or tape. Such additional storage is illustrated in FIG. 6 by removable storage 612 and non-removable storage 614.

Non-transitory computer-readable media may include volatile and nonvolatile, removable and non-removable tangible, physical media implemented in technology for storage of information, such as computer readable instructions, data structures, program modules, or other data. The memory 602, removable storage 612, and non-removable storage 614 are all examples of non-transitory computer-readable media. Non-transitory computer-readable media include, but are not limited to, RAM, ROM, electronically erasable programmable ROM (EEPROM), flash memory or other memory technology, compact disc ROM (CD-ROM), digital versatile discs (DVD) or other optical storage, magnetic cassettes, magnetic tape, magnetic disk storage or other magnetic storage devices, or any other tangible, physical medium which can be used to store the desired information, which can be accessed by the control system 112. Any such non-transitory computer-readable media may be part of the control system 112 or may be a separate database, databank, remote server, or cloud-based server.

In some implementations, the transceiver(s) 616 include any transceivers known in the art. In some examples, the transceiver(s) 616 can include wireless modem(s) to facilitate wireless connectivity with other components (e.g., between the control system 112 and a wireless modem that is a gateway to the Internet), the Internet, and/or an intranet. Specifically, the transceiver(s) 616 can include one or more transceivers that can enable the control system 112 to send and receive communications, such as the notification that portable power is required in step 508 of method 500. Thus, the transceiver(s) 616 can include multiple single-channel transceivers or a multi-frequency, multi-channel transceiver to enable the control system 112 to send and receive video calls, audio calls, messaging, etc. The transceiver(s) 616 can enable the control system 112 to connect to multiple networks including, but not limited to 2G, 3G, 4G, 5G, and Wi-Fi networks. The transceiver(s) 616 can also include one or more transceivers to enable the control system 112 to connect to future (e.g., 6G) networks, Internet-of-Things (IoT), machine-to machine (M2M), and other current and future networks.

The transceiver(s) 616 may also include one or more radio transceivers that perform the function of transmitting and receiving radio frequency communications via an antenna (e.g., Wi-Fi or Bluetooth®). In other examples, the transceiver(s) 616 may include wired communication components, such as a wired modem or Ethernet port, for communicating via one or more wired networks. The transceiver(s) 316 can enable the control system 112 to facilitate audio and video calls, download files, access web applications, and provide other communications associated with the systems and methods, described above.

In some implementations, the output device(s) 618 include any output devices known in the art, such as a display (e.g., a liquid crystal or thin-film transistor (TFT) display), a touchscreen, speakers, a vibrating mechanism, or a tactile feedback mechanism. Thus, the output device(s) can include a screen or display. The output device(s) 618 can also include speakers, or similar devices, to play sounds or ringtones when an audio call or video call is received. Output device(s) 618 can also include ports for one or more peripheral devices, such as headphones, peripheral speakers, or a peripheral display.

In various implementations, input device(s) 620 include any input devices known in the art. For example, the input device(s) 620 may include a camera, a microphone, or a keyboard/keypad. In some examples, the input device(s) can include an interface an operator uses to notify that portable power is required. The input device(s) 620 can include a touch-sensitive display or a keyboard to enable users to enter data and make requests and receive responses via web applications (e.g., in a web browser), make audio and video calls, and use the standard applications 606, among other things. A touch-sensitive display or keyboard/keypad may be a standard push button alphanumeric multi-key keyboard (such as a conventional QWERTY keyboard), virtual controls on a touchscreen, or one or more other types of keys or buttons, and may also include a joystick, wheel, and/or designated navigation buttons, or the like. A touch sensitive display can act as both an input device 620 and an output device 618.

### INDUSTRIAL APPLICATION

The present disclosure describes managing electrical power at a worksite 100. As worksites increasingly rely on solutions that meet GHG reduction targets, such as electrical power, the dynamic nature of a worksite 100 may require a variability of power sources. The worksite 100 of FIG. 1 provides the grid power supply 124 and the portable power supply 132. The grid power supply 124 is used in areas in which a stationary power supply can be installed. The portable power supply 132 is used in areas in which electrical power is required but the grid power supply 124 is not available or is not the preferred or optimal source of electrical power. The portable power supply 132 can be autonomous vehicles, as illustrated in FIG. 3, that can be moved using remote commands from the control system 112. The portable power supply 132 can be batteries, fuel cells, internal combustion generators, solar cells, and the like that provide power.

Further, because some of the haul trucks 102 may have excess power stored in their batteries, the control system 112 can use the excess power to power other devices or work machines at the worksite 100. The excess energy can be the result of various reasons including, but not limited to, energy generated during regenerative braking, or a battery charge greater than what is required of the haul truck 102. The control system 112 can instruct the haul truck 102 to move to a regenerative capture system 144, where the excess power is transferred from the battery of the haul truck 102 to the regenerative power storage 148. The excess power stored in the regenerative power storage 148 can thereafter be transferred to another haul truck, as illustrated in FIG. 1.

While the foregoing disclosure is described with respect to the specific examples, the scope of the disclosure is not limited to these specific examples. Since other modifications and changes varied to fit particular operating requirements and environments will be apparent to those skilled in the art, the disclosure is not considered limited to the example chosen for purposes of disclosure and covers all changes and modifications which do not constitute departures from the true spirit and scope of this disclosure.

Although the application describes embodiments having specific structural features and/or methodological acts, the claims are not necessarily limited to the specific features or acts described. Rather, the specific features and acts are merely illustrative some embodiments that fall within the scope of the claims of the application.

1. A control system for managing electrical power at a worksite, comprising:
one or more processors; and
one or more non-transitory computer-readable media storing computer-executable instructions that, when executed by the one or more processors, cause the one or more processors to perform acts comprising:
receiving, by the control system, a communication that a first portable power supply disposed at the worksite is required for use by a work machine, the work machine being disposed at the worksite and receiving power from at least one of a grid power supply of the worksite or a second portable power supply;
determining, by the control system, that the first portable power supply is available for use by the work machine; and
based on determining that the first portable power supply is available for use, communicating, by the control system, an instruction to move the first portable power supply a location for use by the work machine.

2. The control system of claim 1, the acts further comprising determining that a battery used by the work machine has a charge sufficient to provide power to operate systems of the work machine while the work machine is removed from the grid power supply or the second portable power supply.

3. The control system of claim 1, wherein the first portable power supply comprises:
a power source comprising a battery, a fuel cell, or an internal combustion engine generator;
tracks which move the first portable power supply from a first location to a second location; and
a first electrical connector configured to provide electrical current to the work machine through a first tether.

4. The control system of claim 3, wherein the first portable power supply further comprises a second electrical connector configured to provide electrical current to the work machine, or to an additional work machine, through a second tether.

5. The control system of claim 1, the grid power supply comprises alternating current power and direct current power.

6. The control system of claim 1, the acts further comprising:
receiving usage data indicating a current electrical load of the work machine is greater than what is available at the worksite; and
providing a command, by the control system, a second instruction to move the second portable power supply the location for use by the work machine.

7. The control system of claim 1, the acts further comprising:
determining that a battery of the work machine has an excess charge; and
based on determining that the battery has the excess charge, providing a command, by the control system, to the work machine to move to and electrically connect with a regenerative capture system.

8. The control system of claim 7, the acts further comprising providing a command, by the control system, to a second work machine to receive the excess charge received from the work machine.

9. The control system of claim 7, wherein the regenerative capture system comprises a battery configured to store the excess charge received from the work machine.

10. The control system of claim 7, wherein the regenerative capture system comprises a hydrogen production unit that generates hydrogen gas using electrolysis of water using the excess charge received from the work machine.

11. A method for managing electrical power at a worksite, comprising:
establishing, by a control system, an energy capacity of a plurality of power sources, the plurality of power sources comprising a grid power supply and a portable power supply;
establishing, by the control system, communication with a work machine located at the worksite;
monitoring, by the control system, a power requirement for the work machine;
receiving, by the control system, a communication that the portable power supply is required for use by the work machine currently using the grid power supply or a second portable power supply;
determining, by the control system, that the portable power supply is available for use by the work machine; and
communicating, by the control system, an instruction to move the portable power supply to a location for use by the work machine.

12. The method of claim 11, wherein the portable power supply comprises:
a power source comprising a battery, a fuel cell, or an internal combustion engine generator;
tracks which move the portable power supply from a first location to a second location; and
a first electrical connector for providing a direct current power supply to a first work machine or a second work machine through a first tether.

13. The method of claim 11, further comprising determining that a battery used by the work machine has a charge sufficient to power the work machine while the work machine is electrically disconnected from the grid power supply or the second portable power supply.

14. The method of claim 11, further comprising receiving a usage data of the work machine, the usage data comprising data of a current electrical load of the work machine or a projected electrical load of the work machine.

15. The method of claim 14, further comprising:
determining that a battery of the work machine has an excess charge; and
providing a command, by the control system, to the work machine to move to and electrically connect with a regenerative capture system, the regenerative capture system comprising a battery for storing the excess charge received from the work machine.

16. The method of claim 15, wherein the regenerative capture system comprises a pantograph assembly having an overhead conductor for electrically connecting to the battery of the work machine to receive the excess charge from the battery of the work machine into the battery of the regenerative capture system.

17. A work machine, comprising:
an electric motor;
a battery powering the electric motor,
an electrical control module (ECM) comprising:
one or more processors; and
one or more non-transitory computer-readable media storing computer-executable instructions that, when executed by the one or more processors, cause the one or more processors to perform acts comprising:
transmitting, to a control system, a request for a portable power supply at a second location, wherein the work machine is currently receiving electrical power from a first power supply at a first location;
transmitting, to the control system, current charge data;
receiving, from the control system a permission notice indicating that the work machine can be disconnected from the first power supply.

18. The work machine of claim 17, the acts further comprising determining that the battery has a charge sufficient to power the work machine while the work machine is electrically disconnected from the first power supply and before the work machine is electrically connected to the portable power supply.

19. The work machine of claim 17, the acts further comprising receiving, from the control system, an indication that the battery of the work machine has an excess charge, wherein the excess charge is to be provided to a second work machine using a regenerative capture system.

20. The work machine of claim 17, wherein the portable power supply comprises an autonomous vehicle comprising:
a power source comprising a battery, a fuel cell, or an internal combustion engine generator;
tracks which move the portable power supply from the first location to the second location; and
a first electrical connector for providing a direct current power supply to the work machine; and
a second electrical connector for providing an alternating current power supply to the work machine.
